(19) United States
(12) Patent Application Publication
(10) Pub. No.: US 2015/0229485 A1
(43) Pub. Date: Aug. 13, 2015

(54) METHOD AND APPARATUS FOR PERFORMING MULTICAST IN ID/LOCATOR SEPARATION ENVIRONMENT

(71) Applicant: ELECTRONICS AND TELECOMMUNICATIONS RESEARCH INSTITUTE, Daejeon (KR)

(72) Inventors: Joo-Chul LEE, Daejeon (KR); Woo-Jik CHUN, Seoul (KR)

(21) Appl. No.: 14/607,288

(22) Filed: Jan. 28, 2015

(30) Foreign Application Priority Data
Feb. 11, 2014 (KR) 10-2014-0015718

(51) Int. Cl. H04L 12/18; H04L 12/741

(52) U.S. Cl. CPC H04L 12/185; H04L 45/745

(57) ABSTRACT

The present invention relates to a method and an apparatus for performing multicast communication in an ID/locator separation environment. The method includes: receiving a packet; determining whether an entry corresponding to a destination ID included in a packet header of the packet is in a forwarding table; forwarding the packet based on a next hop address included in the entry, if the entry corresponding to the destination ID is present. The entry corresponding to the destination ID can include a plurality of next hop addresses if the destination ID is an ID for a multicast group domain, and the step of forwarding the packet can be carried out by copying the packet by as many as the number of next hop addresses and sending the copied packet to each of the next hop addresses.

### CROSS-REFERENCE TO RELATED APPLICATIONS

This application claims the benefit of Korean Patent Application No. 10-2014-0015718, filed with the Korean Intellectual Property Office on Feb. 11, 2014, the disclosure of which is incorporated herein by reference in its entirety.

### BACKGROUND

1. Technical Field

Exemplary embodiments relate to a multicast operation mechanism in an ID/locator separation environment, more specifically to a multicast operation in an ID/locator separation environment that operates based on a recursively and hierarchically configured domain.

2. Background Art

In today's IP-based internet environment, the IP has the role of both the identifier (ID) and the locator. Carrying out these dual roles has been causing problems such as an inefficient routing or an extendibility issue of the routing table in services like mobility or multihoming. Suggested to address these problems has been a solution of separating the ID from the locator. By separating the permanent ID, which is assigned to the subject of communication, from the locator, which indicates the current location where the subject of communication is, it has been possible to guarantee the natural continuity of communication even though the subject of communication moves the location during the communication and to mitigate the extendibility issue of the routing table that occurs in the routing between domains.

In an ID/locator separation environment, as the ID and the locator are separated, the routing table and the forwarding table that are used in the router are also completely separated. Since the IP of the router in the conventional IP environment has taken the roles of both the ID and the locator, the routing table and the forwarding table were actually identical. Accordingly, it has been possible for the router to use the routing table, which was created as a result of performing a routing protocol, for the purpose of forwarding as well. However, in the ID/locator separation environment, each subject of communication handles the locator only, and thus in order for the router to properly forward packets that are send based on the ID, it is necessary to assess the current locator of the subject of communication having the ID, search the routing table based on the assessed locator, assess information on next hop, and then create a forwarding table that is mapped with the ID.

As such, in order to carry out a multicast communication in the ID/locator separation environment, it is necessary to provide a separate forwarding table structure as well as a method for setting a route using said forwarding table structure that can support multicast forwarding.

### SUMMARY

Exemplary embodiments provide a forwarding table structure for multicast forwarding in an ID/locator separation environment and a method for generating and managing the forwarding table structure.

Moreover, exemplary embodiments provide a method for setting a route and forwarding multicast packets by use of the multicast forwarding table in accordance with the present invention in an ID/locator separation environment.

Illustrative, non-limiting embodiments may overcome the above disadvantages and other disadvantages not described above. The present invention is not necessarily required to overcome any of the disadvantages described above, and the illustrative, non-limiting embodiments may not overcome any of the problems described above. The appended claims should be consulted to ascertain the true scope of the invention.

According to an aspect of exemplary embodiments, there is provided a method for performing multicast communication in an ID/locator separation environment. The method includes: receiving a packet; determining whether an entry corresponding to a destination ID included in a packet header of the packet is in a forwarding table; forwarding the packet based on a next hop address included in the entry, if the entry corresponding to the destination ID is present. The entry corresponding to the destination ID may include a plurality of next hop addresses if the destination ID is an ID for a multicast group domain, and the step of forwarding the packet may be carried out by copying the packet by as many as the number of next hop addresses and sending the copied packet to each of the next hop addresses

According to an exemplary embodiment, the forwarding table may further include a multicast flag item in the entry for indicating whether the entry is for multicast or unicast.

According to an exemplary embodiment, the method may further include updating the forwarding table, if there is no forwarding entry corresponding to the destination ID.

According to an exemplary embodiment, the packet header may further include a join/leave flag field for indicating joining/leaving a multicast group.

According to an exemplary embodiment, the method may further include: checking a flag value of the packet header for joining/leaving a multicast group; and updating the forwarding table if the flag value indicates joining or leaving.

According to an exemplary embodiment, the step of updating the forwarding table may include: obtaining information on a locator set mapped to the destination ID from an ID/locator mapping system (ILMS); searching a routing table for next hop and output interface information corresponding to each locator of the locator set; adding the searched next hop and output interface information to an entry of the forwarding table by associating the searched next hop and output interface information with the destination ID if the searched next hop and output interface information is new; and if next hop information unrelated to the locator is in the entry of the forwarding table, deleting the next hop information.

According to an exemplary embodiment, the method may further include dropping the packet if the obtained information on the locator set is empty.

According to an exemplary embodiment, a communication node that transmitted a packet by setting a value indicating joining a multicast group in the join/leave flag field of the packet header registers a locator of the communication node in an entry related to the ID for the multicast group domain in the ILMS.

According to an exemplary embodiment, a communication node that transmitted a packet by setting a value indicating leaving a multicast group in the join/leave flag field of the packet header deletes a locator of the communication node in an entry related to the ID for the multicast group domain in the ILMS.

According to yet another aspect of an exemplary embodiment, there is provided a domain gateway apparatus for performing multicast communication in an ID/locator separation environment. The domain gateway apparatus includes a processor and a memory having a routing table, a forwarding table and program instructions executed by the processor stored therein, and the program instructions may be executed by the processor to perform operations comprising: determining, in case a packet is received, whether an entry corresponding to a destination ID included in a packet header of the packet is in the forwarding table; forwarding the packet based on a next hop address included in the entry, if the entry corresponding to the destination ID is present. The entry corresponding to the destination ID may include a plurality of next hop addresses if the destination ID is an ID for a multicast group domain, and the packet may be copied by as many as the number of next hop addresses and sent to each of the next hop addresses, respectively.

According to an exemplary embodiment, it becomes possible to perform multicast communication in a network constituted with a plurality of hierarchical and recursive domains in an ID/locator separation environment.

### BRIEF DESCRIPTION OF THE DRAWINGS

FIG. 1 illustrates an example of a hierarchical domain network that is built in an ID/locator separation environment to which the present invention is applied.

FIG. 2 illustrates a basic structure of a packet header with an extended definition in accordance with an embodiment of the present invention in an ID/locator separation environment.

FIG. 3 illustrates the structure of a forwarding table that can support multicast in accordance with an embodiment of the present invention.

FIG. 4 is a flow diagram showing the steps for forwarding a packet that are carried out in a domain gateway in accordance with an embodiment of the present invention.

FIG. 5A and FIG. 5B are a flow diagram showing the steps for updating a forwarding table that are carried out in accordance with an embodiment of the present invention.

FIG. 6 is a flow diagram showing the steps for joining a multicast group in accordance with an embodiment of the present invention.

FIG. 7 is a flow diagram showing the steps for leaving a multicast group in accordance with an embodiment of the present invention.

FIG. 8A, FIG. 8B and FIG. 8C show examples of forwarding tables generated for multicast communication of multicast group “DomMulticast1” in the domain network shown in FIG. 1.

FIG. 9 illustrates the configuration of a member node and/or domain gateway apparatus.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain relevant conventional technology is determined to evade the point of the present invention, the pertinent detailed description will be omitted.

Unless otherwise stated, any expression in singular form in the description and the claims shall be interpreted to generally mean “one or more.”

Moreover, any terms “module,” “unit,” “interface,” etc, used in the description shall generally mean computer-related objects and can mean, for example, hardware, software and a combination thereof.

Prior to describing the present invention, key terms used in the present invention will be described hereinafter.

Hierarchical Domain Network

An ID/locator separation environment referred to in this specification is basically constituted with a network of hierarchical domains. Each of the domains is constituted with nodes that use a physically-identical transmission protocol. Moreover, each of the domains can be defined as a group of nodes having a common region or similar purpose of communication. Each domain is assigned with an identifier (ID), which simply is a bitstream and thus has no special meaning. Through the connection of the domain ID, relative position information becomes available, making the ID function as a locator. Therefore, boundary routers (domain gateway) of the domains in the ID/locator separation environment can use this locator value as information exchanged during inter-domain routing.

Multicast

In contrast to unicast, multicast is a communication method in which members joined in a multicast group can receive identical data. It is different from broadcast, in which every node belonging to a link receives data A multicast group address is not assigned to a particular node, and by sending a packet to this multicast address, data will be received only by the members having joined the multicast address. The group members can decide whether to receive the data or not, by joining or leaving the multicast group. Generally, multicast-supporting routers manages the multicast group members through a multicast routing protocol and transfers the received multicast packet to the members by copying the received multicast packet.

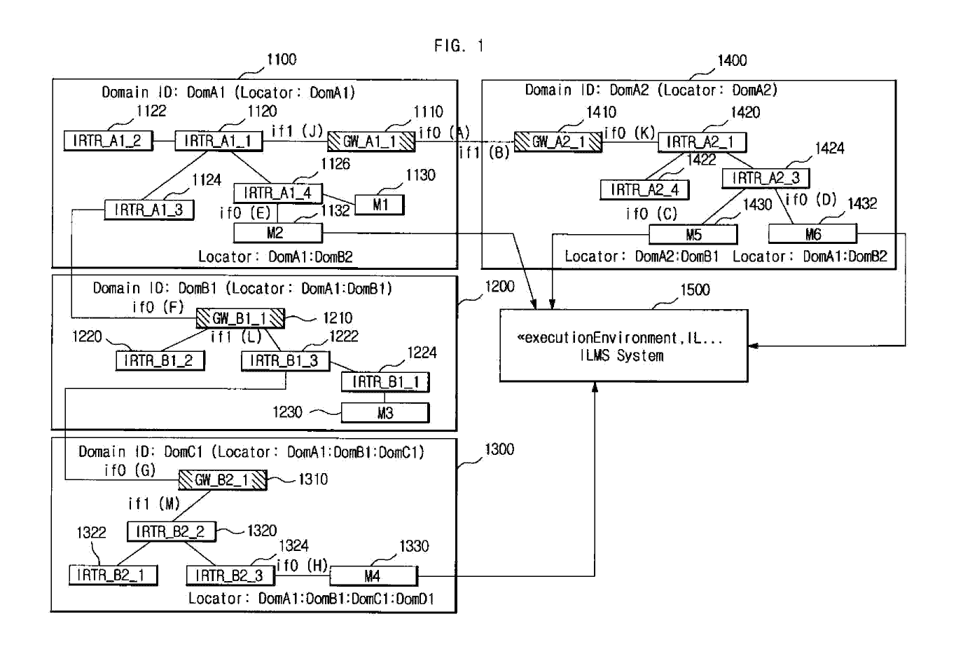

Hereinafter, various embodiments of the present invention will be described with reference to FIGS. 1 to 7.

FIG. 1 illustrates an example of a hierarchical domain network that is built in an ID/locator separation environment to which the present invention can be applied. The hierarchical domain network shown in FIG. 1 is constituted with 4 domains, namely, DomA1 1100, DomA2 1200, DomB1 1300 and DomC1 1400. The domains include domain gateways 1110, 1210, 1310, 1410 for performing inter-domain routing, intra-domain routers 1120-1124, 1220-1224, 1320-1324, 1420-124 connected to the domain gateways, and members 1 to 6 1130, 1132, 1230, 1232, 1330, 1430, which are hosts connected to the routers.

ILMS (ID Locator Mapping System) 1500 is a system for managing mapping between an ID and a locator in the ID/locator separation environment.

As described above, a domain is normally constituted with nodes that have a physically-identical communication protocol and have regionally-similar localities or a common purpose of communication, but the present invention intends to extend this physical concept to apply a logical domain to a single “object of service” such as multicast.

Moreover, the ID is normally assigned to a physically-present subject of communication and is included in a packet header. In the present invention, this concept of ID is expanded to allow a logical domain ID assigned to the “object of service” to be used in a destination ID.

In FIG. 1, it is assumed that members 2, 4, 5, 6 belong to a single multicast group domain and that an ID of “DomMulticast1” for the multicast group domain is registered in the ILMS 1500.

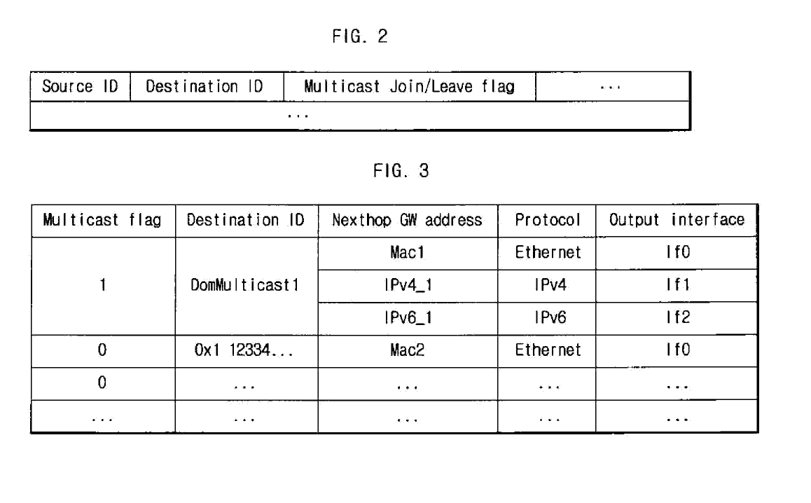

FIG. 2 illustrates a basic structure of a packet header with an extended definition in accordance with an embodiment of the present invention in, an ID/locator separation environment.

As illustrated, the structure of the packet header with an extended definition in accordance with the present invention can basically include a source ID field 210 and a destination ID field 220 and additionally include a multicast join/leave flag field 230. The length of an ID field depends on how it is embodied and thus is not limited to what is described in the present invention.

In an example, the multicast join leave flag field 230 can be defined as follows.

0x00: none

0x01: join (The member sending this packet joins the multicast group domain shown in the destination ID.)

0x02: leave (The member sending this packet leaves the multicast group domain shown in the destination ID.)

FIG. 3 illustrates the structure of a forwarding table that can support multicast in accordance with an embodiment of the present invention.

As illustrated, entries of the forwarding table basically define a next hop address, a communication protocol, an output interface, etc. for a destination ID, and it is possible to have a multicast flag added for indicating whether the entry is for multicast or for unicast, in accordance with an embodiment of the present invention.

Owing to this structure of the forwarding table for multicast, packets can be copied to the domain in which the members belonging to the multicast group are present by as many as the number of next hop addresses mapped to the multicast group ID, and can be each sent to a next hop.

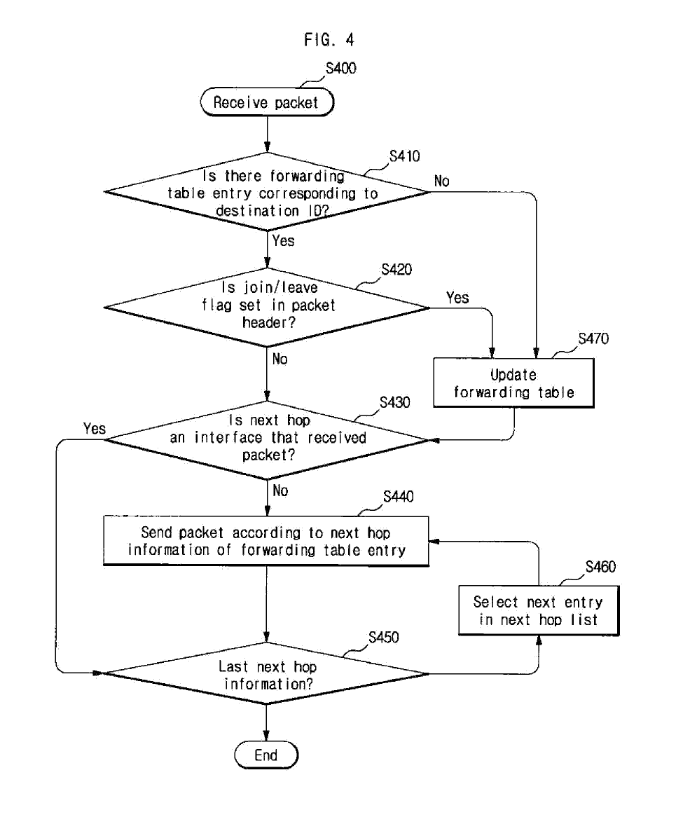

FIG. 4 is a flow diagram showing the steps for forwarding a multicast packet that are carried out in a domain gateway in accordance with an embodiment of the present invention.

In step S400, a packet is received.

In step S410, it is determined whether there is an entry in a forwarding table that corresponds to a destination ID included in a packet header of the pertinent packet.

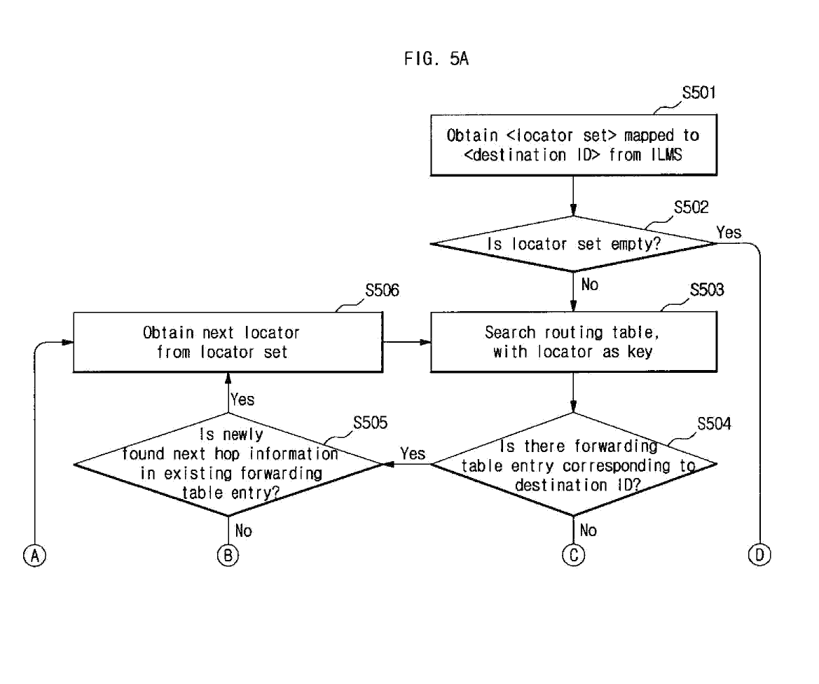

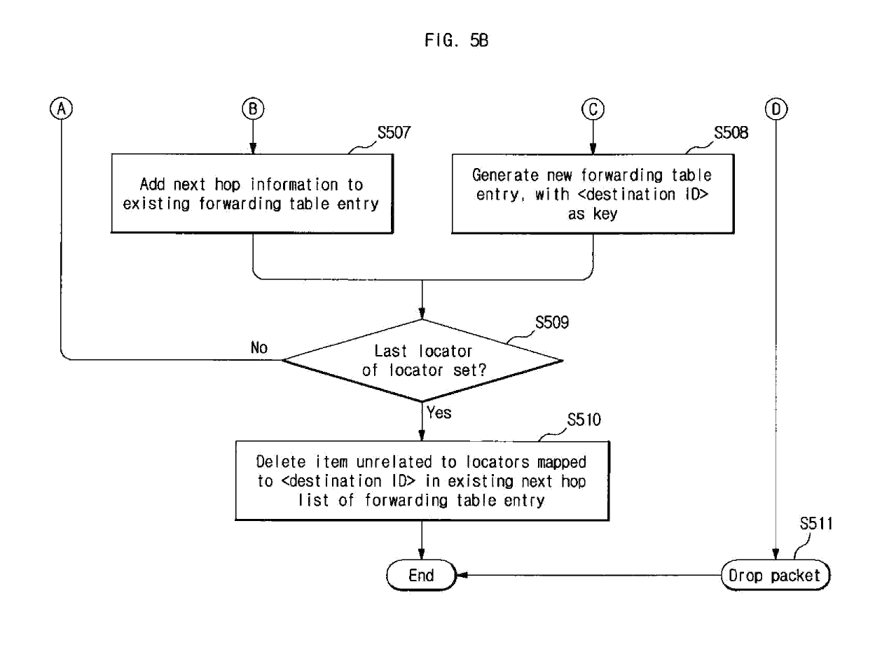

If it is determined that there is no entry corresponding to the destination ID, step 470, which will be described in detail with reference to FIG. 5A and FIG. 5B, is carried out to update the forwarding table.

If, on the other hand, it is determined that there is an entry in the forwarding table that corresponds to the destination ID, step 420 is carried out to determine whether a multicast join/leave flag is set in the corresponding packet header.

In the case where a multicast join/leave flag is set in the packet header, it is determined that a host having sent the packet intends to join/leave a multicast group, and the step S470 of updating the forwarding table will be carried out accordingly.

On the other hand, in the case where the multicast join/leave flag is not set in the packet header, the packet will be forwarded to an address of next hop in the forwarding table in order to forward the packet. The packet is copied by the number of next hop information and forwarded. However, if the next hop is identical to an interface that received the packet, the pertinent packet is skipped. Specifically, it is determined whether the next hop is the interface that received the pertinent packet (S430), and if the next hop is not the interface that received the pertinent packet, the packet is transmitted (S440), and the packet will be repeatedly transmitted until a last next hop address is reached (S440 to S460).

FIG. 5A and FIG. 5B are a flow diagram showing the steps for updating the forwarding table that are carried out in accordance with an embodiment of the present invention.

In step S501, a locator set (<locator set>) that is mapped for a destination multicast group domain ID is obtained from an ILMS.

In step S502, it is determined whether the locator set is empty, and if the locator set is empty, a packet is dropped (S511).

In step S503, a routing table is searched, with each locator in the locator set as a key value, and a matching entry is found.

In step S504, it is checked first whether there is a forwarding table corresponding to a destination ID, and if there is such a forwarding table, it is checked whether next hop information of the routing table searched in the step S503 is in the forwarding table. If such next hop information is in the forwarding table, next step is skipped (S506), and if such next hop information is not in the forwarding table, next hop information is added to the forwarding table (S507). The step 503 is carried out for every locator (S505 and S506).

On the other hand, if there is no forwarding table corresponding to the destination ID, <next hop>, which is searched in the routing table for the pertinent destination ID, and <output interface> are combined to generate a new forwarding entry (e.g., {destination ID>, <nexthop addr1, output interface1>, <nexthop addr2, output interface2> . . . }) and add the new forwarding entry to the forwarding table (S508, S509).

Moreover, if next hop information that is unrelated to the locator mapped with the multicast group domain ID is in the forwarding table entry, such information can be deleted (S510).

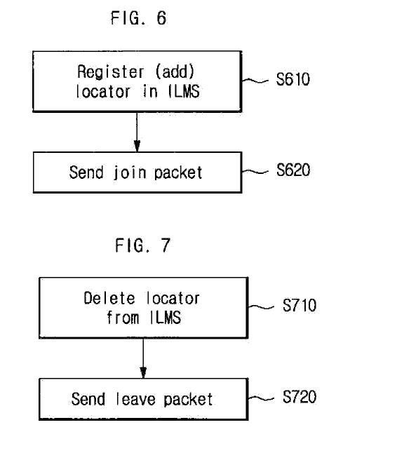

FIG. 6 is a flow diagram showing the steps for joining a multicast group in accordance with an embodiment of the present invention.

Joining a multicast group in an ID/locator separation environment can be made by carrying out a plug-in to a logical multicast group domain.

Specifically, when a member desiring, to join the multicast group is plugged in to a multicast group domain socket, a communication node registers a locator in which the current member is located in a multicast group domain ID entry of an ILMS (S610).

Then, in order to update a forwarding table for forwarding a multicast packet, a packet having a join flag set therein is transmitted by setting the multicast group domain as a destination ID (S620). A domain gate way that received the packet will update a multicast forwarding table in order to forward the multicast packet to the node that has sent the packet.

FIG. 7 is a flow diagram showing the steps for leaving the multicast group in accordance with an embodiment of the present invention.

Leaving the multicast group in the ID/locator separation environment can be made by carrying out a plug-out from the logical multicast group domain.

Specifically, when a particular node is plugged out from the multicast group domain socket, the communication node deletes the locator of the current node that is registered in the multicast group domain ID entry of the ILMS (S710).

Then, in order to update the forwarding table for forwarding the multicast packet, a packet having a leave flag set therein is transmitted by setting the pertinent multicast group domain ID as a destination. The multicast forwarding table will be updated by a domain gate way that received the pertinent packet.

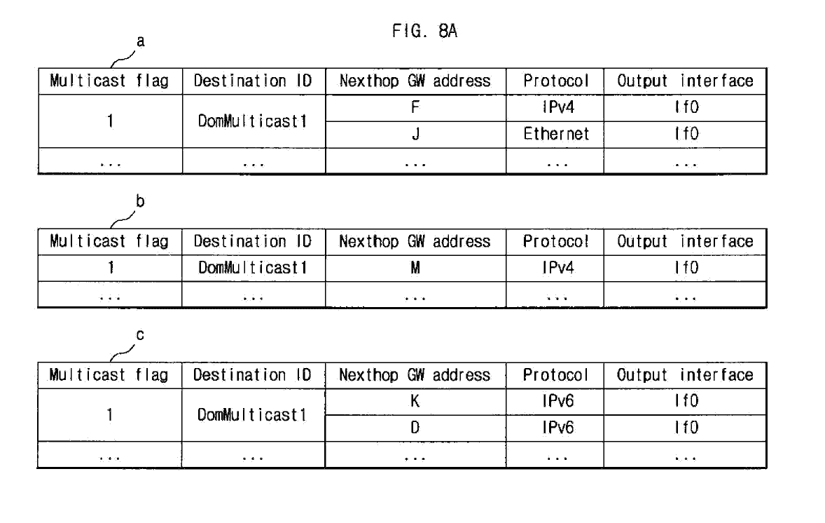

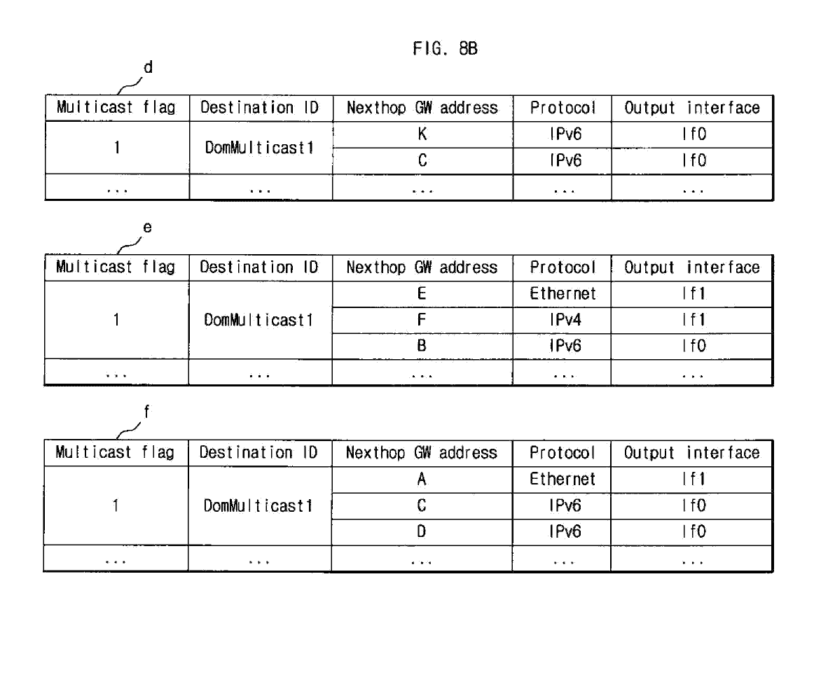

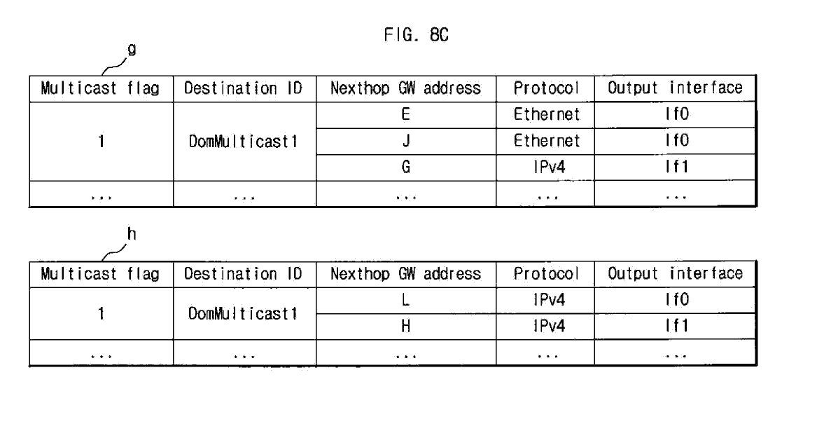

FIG. 8A, FIG. 8B and FIG. 8C show examples of forwarding tables generated for multicast communication of multicast group “DomMulticast1” in the domain network shown in FIG. 1

As an example shown in FIG. 1, a mapping table of an ILMS has [DomMulticast1, {DomA1:DomB2, DomA2:DomB1, DomA2:DomB2, DomA1:DomB1:DomC1:DomD1}] registered therein for “DomMulticast1,” which is a multicast group domain including members 2, 4, 5 and 6, and the forwarding tables of the member nodes and domain gateways are illustrated in FIG. 8A, FIG. SB and FIG. 8C. Specifically, the tables indicated with “a” through “d” illustrate forwarding tables of member nodes 2, 4, 5 and 6 (reference numerals 1132, 1330, 1430 and 1432), respectively, and the tables indicated with “e” through “h” illustrate forwarding tables of domain gateways GW_A1_1 (1110), GW_A2_1 (1410), GW_B1_1 (1210) and GW_B2_1 (1310), respectively.

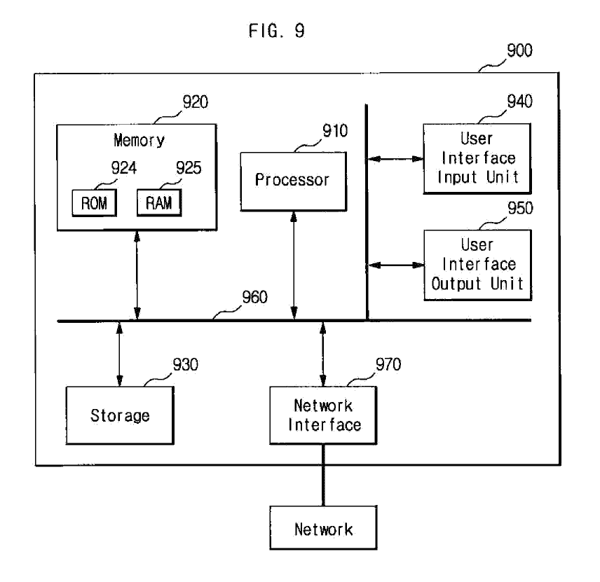

FIG. 9 illustrates the configuration of a computer system implementing a member node and/or domain gateway.

As shown in in FIG. 9, a computer system 900 may include one or more of a processor 910, a memory 920, a storage 930, a user interface input unit 940, and a user interface output unit 950, each of which communicates through a bus 960. The computer system 900 may also include a network interface 970 that is coupled to a network. The processor 910 may be a central processing unit (CPU) or a semiconductor device that executes processing instructions stored in the memory 920 and/or the storage 930. The memory 920 and the storage 930 may include various forms of volatile or non-volatile storage media. For example, the memory may include a read-only memory (ROM) 924 and a random access memory (RAM) 925.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The program instructions stored in the computer readable medium can be designed and configured specifically for the present invention or can be publically known and available to those who are skilled in the field of software. Examples of the computer readable medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of the present invention, and the opposite is also possible.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. A method for performing multicast communication in an ID/locator separation environment, comprising:
receiving a packet;
determining whether an entry corresponding to a destination ID included in a packet header of the packet is in a forwarding table;
forwarding the packet based on a next hop address included in the entry, if the entry corresponding to the destination ID is present,
wherein the entry corresponding to the destination ID includes a plurality of next hop addresses if the destination ID is an ID for a multicast group domain, and the forwarding of the packet is carried out by copying the packet by as many as the number of next hop addresses and sending the copied packet to each of the next hop addresses.

2. The method of claim 1, wherein the forwarding table further comprises a multicast flag item in the entry for indicating whether the entry is for multicast or unicast.

3. The method of claim 1, further comprising updating the forwarding table, if there is no, forwarding entry corresponding to the destination ID.

4. The method of claim 1, wherein the packet header further comprises a join/leave flag field for indicating joining/leaving a multicast group.

5. The method of claim 4, further comprising:
checking a flag value of the packet header for joining/leaving a multicast group;
updating the forwarding table if the flag value indicates joining or leaving.

6. The method of claim 3, wherein the updating of the forwarding table comprises:
obtaining information on a locator set mapped to the destination ID from an ID/locator mapping system (ILMS);
searching a routing table for next hop and output interface information corresponding to each locator of the locator set;
adding the searched next hop and output interface information to an entry of the forwarding table by associating the searched next hop and output interface, information with the destination ID if the searched next hop and output interface information is new; and
if next hop information unrelated to the locator is in the entry of the forwarding table, deleting the next hop information.

7. The method of claim 6, further comprising dropping the packet if the obtained information on the locator set is empty.

8. The method of claim 5, wherein the updating of the forwarding table comprises:
obtaining information on a locator set mapped to the destination ID from an ID/locator mapping system (ILMS);
searching a routing table for next hop and output interface information corresponding to each locator of the locator set;
adding the searched next hop and output interface information to an entry of the forwarding table by associating the searched next hop and output interface information with the destination ID if the searched next hop and output interface information is new; and
if next hop information unrelated to the locator is in the entry of the forwarding table, deleting the next hop information.

9. The method of claim 8, further comprising dropping the packet if the obtained information on the locator set is empty.

10. The method of claim 4, wherein a communication node that transmitted a packet by setting a value indicating joining a multicast group in the join/leave flag field of the packet header registers a locator of the communication node in an entry related to the ID for the multicast group domain in the ILMS.

11. The method of claim 4, wherein a communication node that transmitted a packet by setting a value indicating leaving a multicast group in the join/leave flag field of the packet header deletes a locator of the communication node in an entry related to the ID for the multicast group domain in the ILMS.

12. A domain gateway apparatus for performing multicast communication in an ID/locator separation environment, the apparatus comprising a processor and a memory having a routing table, a forwarding table and program instructions executed by the processor stored therein, the program instructions being executed by the processor to perform operations comprising:
determining, when a packet is received, whether an entry corresponding to a destination ID included in a packet header of the packet is in the forwarding table;
forwarding the packet based on a next hop address included in the entry, if the entry corresponding to the destination ID is present,
wherein the entry corresponding to the destination ID includes a plurality of next hop addresses if the destination ID is an ID for a multicast group domain, and the packet is copied by as many as the number of next hop addresses and sent to each of the next hop addresses, respectively.

13. The apparatus of claim 12, wherein the forwarding table further comprises a multicast flag item in the entry for indicating whether the entry is for multicast or unicast.

14. The apparatus of claim 13, wherein the operations further comprise updating the forwarding table, if there is no entry corresponding to the destination ID.

15. The apparatus of claim 12, wherein the packet header further includes a join/leave flag field for indicating joining/leaving a multicast group.

16. The apparatus of claim 15, wherein the operations further comprise:
checking a flag value of the packet header for joining/leaving a multicast group, and
updating the forwarding table if the flag value indicates joining or leaving.

17. The apparatus of claim 12, wherein the operations for updating the forwarding table comprises:
obtaining information on a locator set mapped to the destination ID from an ID/locator mapping system (ILMS);
searching a routing table for next hop and output interface information corresponding to each locator of the locator set;
adding the searched next hop and output interface information to an entry of the forwarding table by associating the searched next hop and output interface information with the destination ID if the searched next hop and output interface information is new; and
if next hop information unrelated to the locator is in the entry of the forwarding table, deleting the next hop information.

18. The apparatus of claim 17, wherein the operations further comprise dropping the packet if the obtained information on the locator set is empty.

19. The apparatus of claim 14, wherein the operations for updating the forwarding table comprises:
obtaining information on a locator set mapped to the destination ID from an ID/locator mapping system (ILMS);
searching a routing table for next hop and output interface information corresponding to each locator of the locator set;
adding the searched next hop and output interface information to an entry of the forwarding table by associating the searched next hop and output interface information with the destination ID if the searched next hop and output interface information is new; and
if next hop information unrelated to the locator is in the entry of the forwarding table, deleting the next hop information.

20. The apparatus of claim 19, wherein the operations for updating the forwarding table comprises:
dropping the packet if the obtained information on the locator set is empty.
